(19) United States
(12) Patent Application Publication
(10) Pub. No.: US 2026/0127993 A1
(43) Pub. Date: May 7, 2026

(54) SWITCHING DITHER PATTERNS BASED ON REAL-TIME IMAGE SOURCE DETECTION

(71) Applicant: DELL PRODUCTS L.P., Round Rock, TX (US)

(72) Inventors: Hyunseok Ko, Singapore (SG); Dengzhai Xiong, Singapore (SG)

(21) Appl. No.: 18/940,544

(22) Filed: Nov. 7, 2024

(51) Int. Cl. G09G 3/20

(52) U.S. Cl. CPC G09G 3/2055; G09G 2320/0613; G09G 2320/0666; G09G 2340/0428; G09G 2360/06; G09G 2370/20

(57) ABSTRACT

A display device includes a processor and a memory coupled to the processor. The display device may be configured to receive information associated with an operating system, a central processing unit, and a graphics processing unit of an information handling system. The display device may also be configured to determine a set of dither patterns based on the received information that is associated with the operating system, central processing unit, and graphics processing unit of the information handling system. In addition, the display device may be configured to apply the set of dither patterns to an image prior to displaying the image at the display device.

### FIELD OF THE DISCLOSURE

The present disclosure generally relates to information handling systems, and more particularly relates to switching dither patterns based on real-time image source detection.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communication among information handling systems may be via networks that are wired, wireless, or some combination.

### SUMMARY

A display device includes a processor and a memory coupled to the processor. The display device may be configured to receive information associated with an operating system, a central processing unit, and a graphics processing unit of an information handling system. The display device may also be configured to determine a set of dither patterns based on the received information that is associated with the operating system, central processing unit, and graphics processing unit of the information handling system. In addition, the display device may be configured to apply the set of dither patterns to an image prior to displaying the image at the display device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system for switching dither patterns based on real-time image source detection, according to an embodiment of the present disclosure;

FIG. 2 is a flowchart of a method for switching dither patterns based on real-time image source detection, according to an embodiment of the present disclosure;

FIG. 3 is a diagram of an on-screen display user interface for selecting an ecosystem configuration, according to an embodiment of the present disclosure; and

FIG. 4 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Different types of display devices typically require different formats of data to display. For example, a 640×480 display, with each pixel having one of 256 colors selected from a larger group of 262, 144 possible colors, is commonly used in personal computers. However, other display devices, such as those that do not use a Video Electronics Standards Association (VESA) standard video basic input/output system (BIOS) or cannot support 256 colors, instead may only utilize 16 colors. As a result, any 256-color images are generally converted to 16 colors. One of the methods to display images on a reduced color set, such as a 256-color source image to a 16-color target image is dithering.

Dithering involves interspersing colors to fool the eye into seeing a third or intermediate color. While dithering usually supplies more color precision, it is at a cost of image detail. Such image details can be critical. For example, in graphic images including a combination of text and background, if the image detail is lost, the text blends into the background and becomes difficult to read. However, different platforms perform their dithering algorithm, if any. For example, one platform processor may perform a dithering process prior to transmitting a graphic image for display. However, the platform processor typically does not perform a dithering process to the graphic image prior to transmitting it for display. As such, when a display device performs its own dithering process using a set of dither patterns, the resulting graphic image on display may be different when the source of the graphic image is the first platform processor compared to the second platform processor for example. In particular, in some instances, a front-of-screen issue, such as a series of crosslines, vertical lines, or horizontal lines on certain gray levels was seen with graphic images from the first platform processors. As such, there is a need to account for the system configuration of an image source when applying the dithering process to an image prior to display. Accordingly, the present disclosure provides a system and method to switch among different dither patterns based on the system configuration of the image source in real-time.

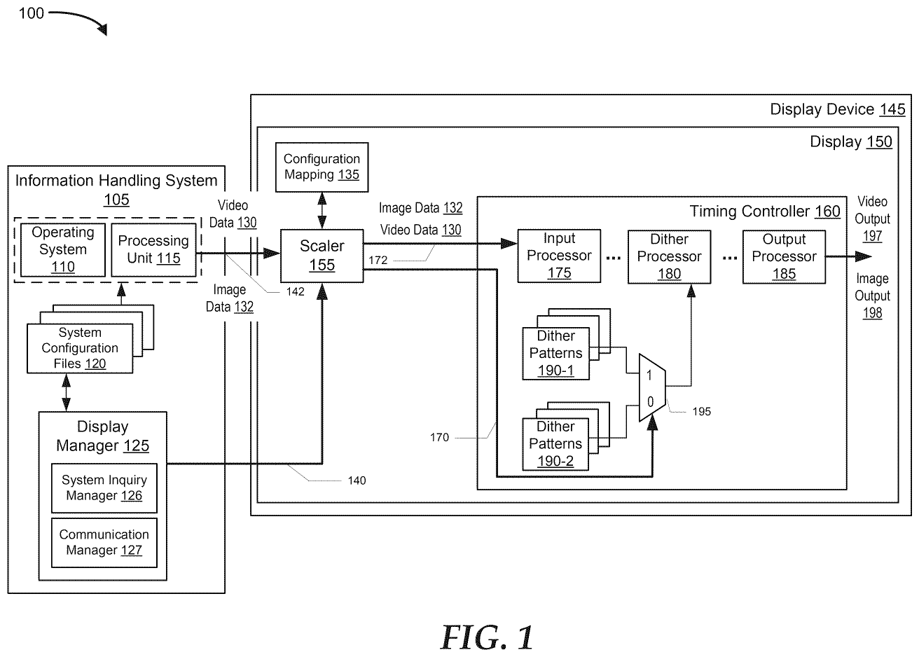

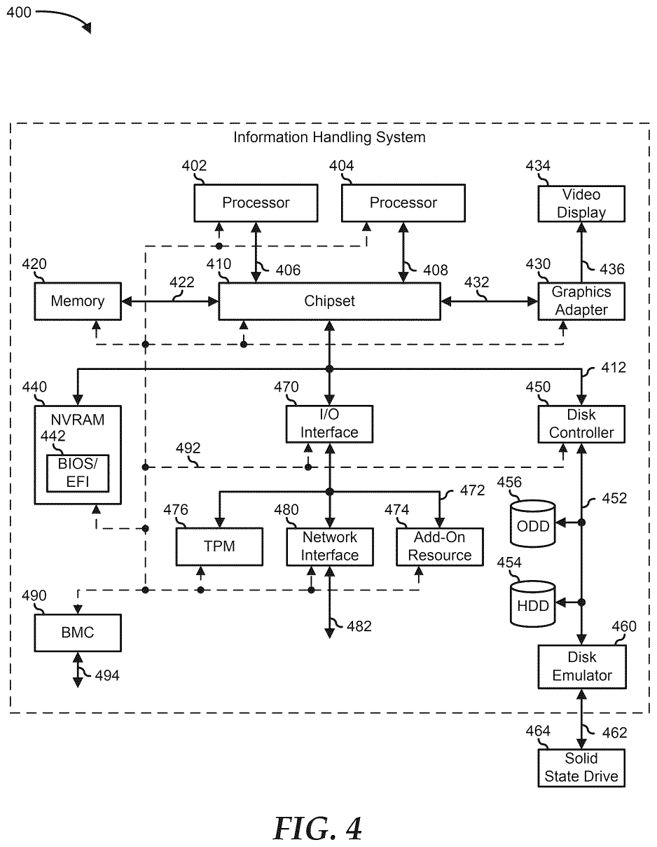

FIG. 1 illustrates a portion of a system 100 configured to switch among different dither patterns based on detecting an image source in real-time, according to an embodiment of the present disclosure. System 100 includes an information handling system 105 and a display device 145. Information handling system 105, which is similar to an information handling system 400 of FIG. 4, includes an operating system (OS) 110, a processing unit 115, a system configuration file 120, and a display manager 125. Display device 145, which is similar to a video display 434 of FIG. 4, includes a display 150 which further includes a scaler 155 and a timing controller 160. Timing controller 160 includes an input processor 175, a dither processor 180, an output processor 185, dither patterns 190-1 and 190-2, and a multiplexer 195.

Processing unit 115 and display manager 125 may be communicatively coupled to each other and to scaler 155 which is communicatively coupled to timing controller 160. However, any variety of connections between components of information handling system 105 and display device 145 are envisioned as falling within the scope of the present disclosure. In addition, connections between components may be omitted for descriptive clarity.

Typically, a timing controller of an information handling system utilizes a single dither pattern to improve the image quality of a display device by simulating additional colors and/or shades than available. However, the dither pattern may improve the image quality of one ecosystem configuration but not of another ecosystem configuration. Accordingly, a single dither pattern cannot be used for different ecosystem configurations, wherein an ecosystem configuration includes a combination of OS, central processing unit (CPU), and graphics processing unit (GPU) configuration. The present disclosure provides a system and method to automatically detect the ecosystem configuration and apply a dither pattern based on the configuration in real-time. This allows image quality improvement across different ecosystem configurations even when a user updates the OS, CPU, and GPU to something different than provided by a manufacturer of the information handling system.

Information handling system 105 may include portable and non-portable information handling systems. For example, information handling system 105 may include a personal computer such as a desktop computer, a laptop computer, a mobile computer, and/or a notebook computer. OS 110 is a software program that manages various hardware and software components of information handling system 105, such as display manager 125 and processing unit 115. Processing unit 115 represents a CPU, GPU, or a combination thereof. For example, processing unit 115 may be a CPU, GPU, or system-on-chip (SOC) with both a CPU and GPU. The CPU may be similar to processors 402 and 404 of FIG. 4 while GPU may be similar to graphics adapter 430 of FIG. 4. Accordingly, processing unit 115 may be any system, device, or apparatus that is configured to transmit digital images, such as video data 130 and image data 132 to scaler 155 via an interface 142. Interface 142 may be DisplayPort^{TM}, digital video interface (DVI), High-Definition Multimedia Interface (HDMI), or similar.

System configuration file 120 may include one or more configuration files used to configure parameters and/or settings for processes, OS, etc. of information handling system 105. In addition, system configuration file 120 may include identifying information associated with OS 110, processing unit 115, CPU, and/or GPU. For example, system configuration file 120 may include information on whether the CPU of information handling system 105 is an Apple M1®/M2®, Intel i5®/i7®, Qualcomm Snapdragon®, etc. In addition, system configuration file 120may include information regarding the manufacturer of the CPU or GPU. For example, system configuration files may include information on whether the CPU or GPU of information handling system 105 is manufactured by Intel®, AMD®, or Nvidia®. In another example, system configuration file 120 may include information on whether OS 110 is an Apple iOS®, Microsoft Windows®, Linux® OS, etc.

System configuration file 120 may also include information associated with rendering the digital images in display device 145, such as the type of graphics engine, video format, image format, and compression scheme associated with the digital images, among others. For example, optimization of the set of dither patterns may depend on the type of graphics engine installed in the display, such as whether the graphics engine is configured for gaming, office productivity, etc. The video format generally refers to the types of files used to display video data. The image format generally refers to the types of files used to display image data. There are typically several types of video formats, such as Moving Picture Experts Group 4, QuickTime^{®}video format, Audio Video Interleave, etc. Because applying a dithering algorithm may be based on the video and image format, the type of video and image format may affect which set of dither patterns to use. As such, the optimization of the set of dither patterns may also depend on the format of the digital images for display. Accordingly, the video and image format is one of several factors that determine which set of dither patterns to use in addition to the compression scheme. The compression scheme may refer to a transportation protocol for reducing the size of the video and/or image data for transmission. Other factors may also be used in determining the set of dither patterns in addition to those disclosed herein.

Display Manager 125 may comprise any system, device, or apparatus configured to manage and control settings of display device 145. In one embodiment, display manager 125 is a software package that includes a system inquiry manager 126 and a communication manager 127. System inquiry manager 126 may be configured to query system configuration file 120 for information associated with OS 110, CPU, and GPU of information handling system 105. The information associated with OS 110, the CPU, GPU, and other system information may be simply referred to as ecosystem configuration.

System inquiry manager 126 may also retrieve system configuration not found in system configuration file 120. For example, system inquiry manager 126 may query an OS registry for a graphics engine identifier using an application programming interface. In another example, system inquiry manager 126 may use a shell command to retrieve an OS identifier.

Display manager 125 may also receive the information associated with the system configuration from one or more components of information handling system 105. For example, display manager 125 may receive the information via an embedded controller. The system configuration of information handling system 105 may include information associated with the ecosystem configuration and other hardware or software components of information handling system 105. Display manager 125 or communication manager 127, in particular, may be configured to transmit information associated with the system configuration to scaler 155 via interface 140.

Interface 140 may be similar to interface 142. The information transmitted may include an OS identifier, a CPU identifier, a GPU identifier, or a combination thereof. The information may also include other identifying information associated with one or more factors used in determining a set of optimized dither patterns that may be applied to the image to be displayed. Interface 140 may be a display data channel (DDC), Universal Serial Bus (USB), or similar interface to enable communication between information handling system 105 and display device 145 and/or scaler 155 in particular.

Display device 145 may be any system, device, or apparatus that is similar to video display 434 of FIG. 4, such as a liquid crystal display (LCD), light-emitting diode (LED), organic light-emitting diode (OLED), or other suitable display device depending on configuration of information handling system 105. Display device 145 may be utilized to display information, such as images, streams, and data at display 150, which can be an active display screen area. Display 150 can be an LCD, LED, or OLED display. In one embodiment, display device 145 may be integrated into or distinct from information handling system 105, such as a display monitor.

Scaler 155 may comprise any system, device, or apparatus configured to determine or select a set of dither patterns optimized for the system configuration of information handling system 105 based on the information associated with the system configuration of information handling system 105 that scaler 155 received from display manager 125. The selected set of dither patterns may be among sets of dither patterns optimized for different systems or ecosystem configurations. Scaler 155 may select the set of dither patterns based on configuration mapping 135, which scaler 155 manages and/or maintains.

Configuration mapping 135 may include mappings of known ecosystem and/or system configuration to sets of dither patterns, wherein each combination of the identified OS, CPU, and GPU is mapped to a set of dither patterns that is optimized for that particular combination. For example, each combination may include an OS identifier, CPU identifier, and GPU identifier.

However, the mapping may also include other factors in addition to the OS, CPU, and GPU combination. Configuration mapping 135 may be maintained by scaler 155 in a data structure, such as a table, a linked list, etc. that is stored in a memory accessible by scaler 155 and/or timing controller 160. However, in another embodiment, configuration mapping 135 may be maintained by timing controller 160. Accordingly, in this embodiment, display manager 125 or communication manager 127 in particular, may transmit system configuration information and other factors to timing controller 160 instead of scaler 155. As such, timing controller 160 may determine or select the set of dither patterns optimized for the system configuration and other factors as applicable.

After determining or selecting the set of dither patterns, scaler 155 may then communicate identifying information of the selected set of dither patterns to timing controller 160, such as by transmitting a dither pattern switch signal using interface 170. Interface 170 may be at least one external pin, an Inter-Integrated Circuit (I²C) interface, or similar. The number of pins allows flexibility and control on how many sets of dither patterns can be used. In this example, interface 170 may be a single pin that allows two sets of dither patterns to choose from, dither patterns 190-1 and 190-2. In another example, if there are two pins, then timing controller 160 can have up to four sets of dither patterns, wherein each pin can have two bits. In yet another example, if an I²C interface is used, an eight-bit can be assigned at a specific address in timing controller 160, such that scaler 155 can overwrite corresponding I²C values for the selection of a dither pattern. For example, address 0x00 can be associated with a dither pattern set A, 0x01 can be associated with dither pattern set B, and so on up to dither pattern 0xFF, which can be associated with a dither pattern set 255.

Video data 130 includes moving images, such as a video graphic image from a video source. The video source can include any variety of video processing components configured to generate image content for display, including, but not limited to, a digital signal processor, a television tuner, a video recorder, and the like. Video data 130 may be of various formats, such as video graphics array, DisplayPort™, DVI, HDMI, etc. Image data 132 includes still images and can be of various formats, such as Joint Photographic Experts Group, Portable Network Graphics, etc. Video data 130 and image data 132 may be transmitted by processing unit 115, the CPU and/or GPU of information handling system 105 to display device 145 or scaler 155 in particular via interface 142. Scaler 155 may transmit video data 130 and image data 132 to timing controller 160 or input processor 175 in particular via an interface 172. Interface 172 may be configured for low voltage differential signaling (LVDS), embedded DisplayPort (eDP) signaling, and V-by-One®, or similar.

Timing controller 160 may comprise any system, device, or apparatus configured to receive video data 130 and image data 132 from scaler 155 and to adjust for image quality, color, and/or brightness by managing and controlling operations of input processor 175, dither processor 180, and output processor 185. Timing controller 160 may also include other types of processing based on the internal architecture of timing controller 160 as indicated by the ellipses. For example, timing controller 160 can perform gamma correction or other display performance enhancements, such as Mura compensation. Input processor 175 may comprise any system, device, or apparatus configured to convert an analog signal to a binary signal. For example, input processor 175 may convert low voltage differential signals to zeros and ones for each red/green/blue pixel. Dither processor 180 may comprise any system, device, or apparatus configured to apply a dithering algorithm to processed video data 130 and image data 132 using the selected dither pattern, among others. Output processor 185 may comprise any system, device, or apparatus configured to convert the zeros and ones of each red/green/blue pixel into another interface to communicate with the display's column drivers, such as a multipoint low voltage differential signaling interface for display at display 150. For example, output processor 185 may provide video output 197 and image output 198 to display 150.

The dither pattern switch signal may be a digital or analog signal transmitted by scaler 155 to multiplexer 195, which may be used by timing controller 160 to select the dither pattern among dither patterns 190-1 and 190-2. The set of dither patterns selected includes parameters that are optimized for the OS, CPU, and/or GPU configuration of the information handling system for optimized front-of-screen performance of display device 145, which can improve image quality of video data 130 and image data 132.

Dither patterns 190-1 and 190-2 are sets of dither patterns, wherein each set includes a series of designed dither patterns that may be used to offset color data on a cyclical basis so that the color data would produce a perceivable color gradient for an OS and processing unit combination. Each set of dither patterns may be described by an integer or float matrix and include optimized parameters for a particular OS with CPU and/or GPU combination. For example, dither patterns 190-1 may include dither patterns for different Apple^{®}OS with a CPU and/or GPU combination. Dither patterns 190-2 may include dither patterns for different Microsoft® OS with a CPU and/or GPU combination.

One of skill in the art will appreciate that timing controller 160 may include more than two sets of dither patterns. Accordingly, multiplexer 195 may include more than two input lines. The number of input lines may correspond to the number of sets of dither patterns. Multiplexer 195 may comprise any system, device, or apparatus configured to switch or select a dither pattern from at least two sets of dither patterns, such as dither patterns 190-1 and dither patterns 190-2 based on the dither pattern switch signal. Although only one multiplexer is shown, one of ordinary skill in the art will appreciate that two or more multiplexers may be used to switch or select a dither pattern from more than two sets of dither patterns.

The operations described herein as being performed by OS 110 and/or display manager 125 may be performed or executed by processing unit 115. Similarly, input processor 175, dither processor 180, and output processor 185 of timing controller 160 may perform any suitable operations to process video and image data and dither patterns 190-1 and 190-2. In addition, those of ordinary skill in the art will appreciate that the configuration, hardware, and/or software components of information handling system 105 may vary. For example, the illustrative components within information handling system 105 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

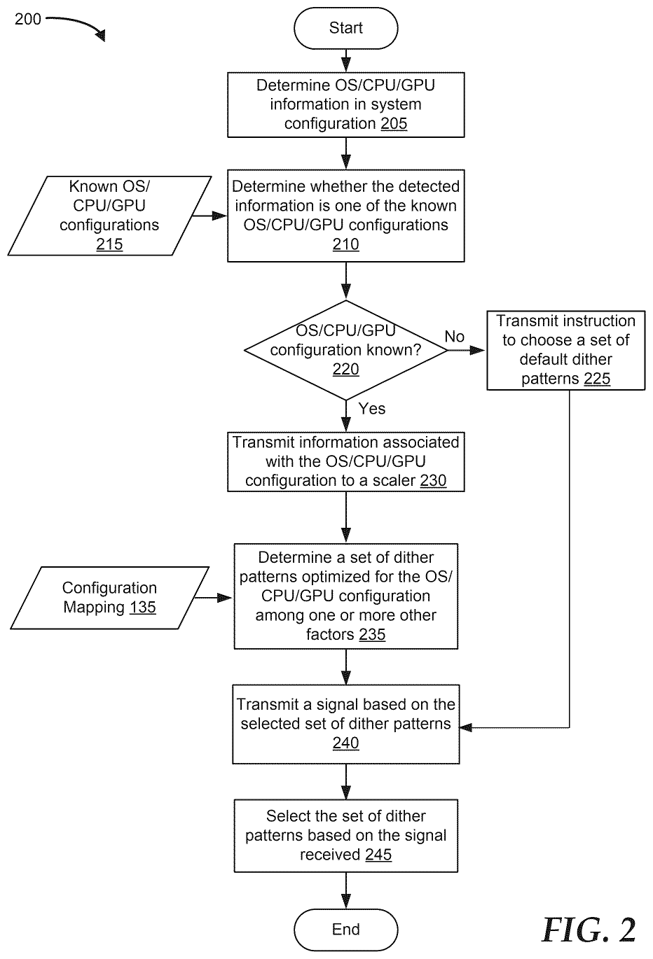

FIG. 2 illustrates a flowchart of a method 200 for applying switched-based dither patterns using real-time video source detection, according to an embodiment of the present disclosure. Method 200 may be performed by any suitable component of system 100 including, but not limited to, information handling system 105 and display device 145 of FIG. 1. While embodiments of the present disclosure are described in terms of the components of system 100 of FIG. 1, it should be recognized that other components may be utilized to perform the described method. In addition, one of skill in the art will appreciate that this flow chart explains a typical example, which can be extended to applications or services in practice. It will be readily appreciated that not every method step set forth in this flow diagram is always necessary and that certain steps of the methods may be combined, performed simultaneously, in a different order, or perhaps omitted, without varying from the scope of the disclosure.

Method 200 typically starts at block 205 wherein a display manager may determine the system configuration of an information handling system that includes OS, CPU, and/or GPU of the information handling system among other information. In addition, the display manager may also determine the type of graphics engine, the video format, and/or compression scheme used by the display device and/or video data or image data. Block 205 may be performed upon the launch of the display manager. In addition, the display manager may also have a background task to monitor changes in the relevant system configuration. For example, the background task can detect a change in video format which may trigger the display manager to perform a query. For example, the background task can periodically poll the OS, CPU, or GPU. The background task can also subscribe to a subscription and notification service for certain system events.

The method proceeds to block 210 where the display manager may determine whether the OS, CPU, and/or GPU configuration are known. For example, the OS, CPU, and/or GPU configuration may be known if it is included in known OS/CPU/GPU configurations 215, which can be configurations that are supported by the information handling system and/or display device. Known OS/CPU/GPU configurations 215 may include identifying information of the OS, CPU, and GPU. Known OS/CPU/GPU configurations 215 may maintained and stored in a memory accessible by the display manager using a data structure, such as a look-up table, list, file, etc.

At decision block 220, the display manager may determine whether the OS, CPU, and/or GPU configuration is one of the known OS, CPU, and/or GPU configurations. If the OS, CPU, and/or GPU configuration is one of the known OS, CPU, and/or GPU configurations, then the “YES” branch is taken, and the method proceeds to block 230. If the OS, CPU, and/or GPU configuration is not one of the known OS, CPU, and/or GPU configurations, then the “NO” branch is taken, and the method proceeds to block 225.

At block 225, the display manager may choose a default set of dither patterns to be applied to the video and/or image data. The method may proceed to block 240. At block 230, the display manager may transmit information associated with the OS, CPU, and/or GPU configuration to a scaler of the display device. The display manager may transmit other information, such as the graphics engine type of the information handling system, the video format of the video and/or image data, compression scheme used for the video and/or image data, among others.

At block 235, the scaler may also use configuration mapping 135 to determine the set of dither patterns associated with the determined OS, CPU, and/or GPU configuration among other factors based on configuration mapping 135. In particular, configuration mapping 135 may include mapping of a combination of OS identifier/CPU identifier, and/or GPU identifier to a dithering pattern identifier. Configuration mapping 135, which can be maintained by the scaler, is a mapping of ecosystem configurations and other factors to a dithering pattern identifier that is associated with a set of dither patterns optimized for that configuration. The method may proceed to block 240 where the scaler may transmit a dither pattern switch signal based on the selected set of dither patterns to a timing controller. In particular, the dither pattern switch signal may be transmitted to a multiplexer of the timing controller. The set of dither patterns may be stored in a memory accessible by the timing controller, wherein each set of dither patterns may be associated with a dithering pattern identifier.

The method may proceed to block 245. At block 245, the timing controller may switch to a set of dither patterns based on the received dither pattern switch signal. For example, if a multiplexer is used, then the dither pattern switch signal may be zero or one, which may be used to switch between two sets of dither patterns. The selected set of dither patterns may be applied by a dithering algorithm to the video and/or image data prior to display. Afterwards, the method ends.

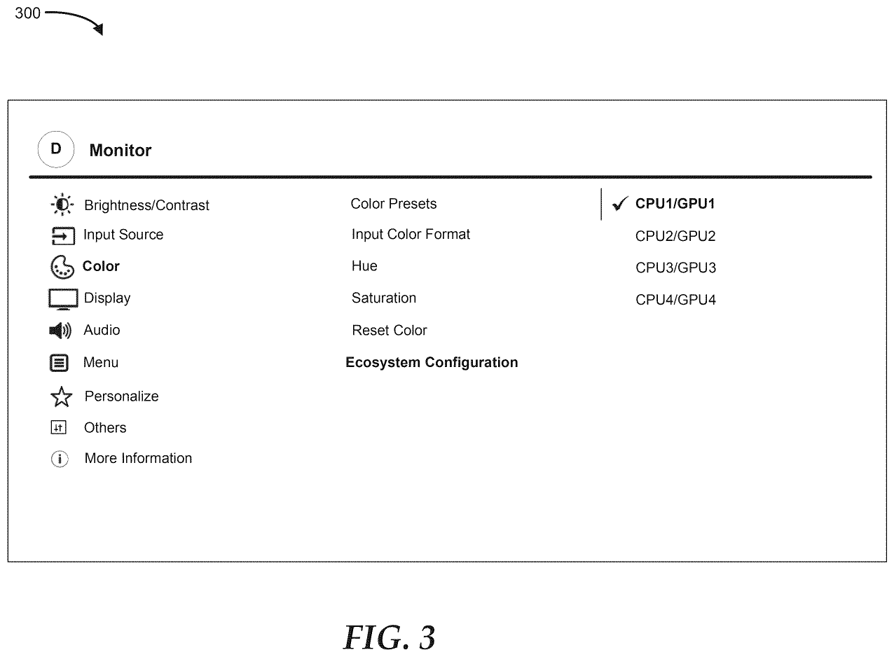

FIG. 3 illustrates a portion of a user interface 300 associated with a display manager for managing and controlling dither patterns switching mechanism based on real-time video source detection. User interface 300 may display an on-screen display menu that includes one or more categories that include one or more settings. For example, a category “Color” includes a sub-category “Ecosystem Configuration” which includes four settings, wherein each setting is a discrete combination of CPU and GPU. User interface 300 may be used by a user to select an ecosystem configuration setting from the four settings. For example, when the user notices an undesired filtering artifact, the user can toggle the dithering pattern by choosing an alternate ecosystem configuration. However, the ecosystem configuration may include at least one setting or more than the four settings depicted. The ecosystem configuration shown in the menu may be maintained and/or stored as known OS/CPU/GPU configurations 215 of FIG. 2. One of skill in the art may appreciate that the menu depicted herein is an example, and various alternate wordings can replace the current wordings upon implementation.

FIG. 4 illustrates an embodiment of information handling system 400 including processors 402 and 404, a chipset 410, a memory 420, a graphics adapter 430 connected to video display 434, a non-volatile RAM (NVRAM) 440 that includes a basic input and output system/extensible firmware interface (BIOS/EFI) module 442, a disk controller 450, a hard disk drive (HDD) 454, an optical disk drive 456, a disk emulator 460 connected to a solid-state drive (SSD) 464, an input/output (I/O) interface 470 connected to an add-on resource 474 and a trusted platform module (TPM) 476, a network interface 480, and a baseboard management controller (BMC) 490. Processor 402 is connected to chipset 410 via processor interface 406, and processor 404 is connected to the chipset via processor interface 408. In a particular embodiment, processors 402 and 404 are connected together via a high-capacity coherent fabric, such as a HyperTransport link, a QuickPath Interconnect, or the like. Chipset 410 represents an integrated circuit or group of integrated circuits that manage the data flow between processors 402 and 404 and the other elements of information handling system 400. In a particular embodiment, chipset 410 represents a pair of integrated circuits, such as a northbridge component and a southbridge component. In another embodiment, some or all of the functions and features of chipset 410 are integrated with one or more of processors 402 and 404.

Memory 420 is connected to chipset 410 via a memory interface 422. An example of memory interface 422 includes a Double Data Rate (DDR) memory channel and memory 420 represents one or more DDR Dual In-Line Memory Modules (DIMMs). In a particular embodiment, memory interface 422 represents two or more DDR channels. In another embodiment, one or more of processors 402 and 404 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 420 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 430 is connected to chipset 410 via a graphics interface 432 and provides a video display output 436 to a video display 434. An example of a graphics interface 432 includes a Peripheral Component Interconnect-Express (PCIe) interface and graphics adapter 430 can include a four-lane (x4) PCIe adapter, an eight-lane (x8) PCIe adapter, a 16-lane (x16) PCIe adapter, or another configuration, as needed or desired. In a particular embodiment, graphics adapter 430 is provided down on a system printed circuit board (PCB). Video display output 436 can include a DVI, an HDMI, a DisplayPort interface, or the like, and video display 434 can include a monitor, a smart television, an embedded display such as a laptop computer display, or the like.

NVRAM 440, disk controller 450, and I/O interface 470 are connected to chipset 410 via an I/O channel 412. An example of I/O channel 412 includes one or more point-to-point PCIe links between chipset 410 and each of NVRAM 440, disk controller 450, and I/O interface 470. Chipset 410 can also include one or more other I/O interfaces, including a PCIe interface, an Industry Standard Architecture (ISA) interface, a Small Computer Serial Interface (SCSI) interface, an I²C interface, a System Packet Interface, a USB, another interface, or a combination thereof. NVRAM 440 includes BIOS/EFI module 442 that stores machine-executable code (BIOS/EFI code) that operates to detect the resources of information handling system 400, to provide drivers for the resources, to initialize the resources, and to provide common access mechanisms for the resources. The functions and features of BIOS/EFI module 442 will be further described below.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an institute of electrical and electronics engineers (IEEE) 1394 (Firewire) interface, a proprietary interface, or a combination thereof. Alternatively, SSD 464 can be disposed within information handling system 400.

I/O interface 470 includes a peripheral interface 472 that connects the I/O interface to add-on resource 474, to TPM 476, and to network interface 480. Peripheral interface 472 can be the same type of interface as I/O channel 412 or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral interface 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on a separate circuit board, or add-in card disposed within information handling system 400, a device that is external to the information handling system, or a combination thereof.

Network interface 480 represents a network communication device disposed within information handling system 400, on a main circuit board of the information handling system, integrated onto another component such as chipset 410, in another suitable location, or a combination thereof. Network interface 480 includes a network channel 482 that provides an interface to devices that are external to information handling system 400. In a particular embodiment, network channel 482 is of a different type than peripheral interface 472 and network interface 480 translates information from a format suitable to the peripheral channel to a format suitable to external devices.

In a particular embodiment, network interface 480 includes a NIC or host bus adapter (HBA), and an example of network channel 482 includes an InfiniBand channel, a Fibre Channel, a Gigabit Ethernet channel, a proprietary channel architecture, or a combination thereof. In another embodiment, network interface 480 includes a wireless communication interface, and network channel 482 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 482 can be connected to an external network resource (not illustrated). The network resource can include another information handling system, a data storage system, another network, a grid management system, another suitable resource, or a combination thereof.

BMC 490 is connected to multiple elements of information handling system 400 via one or more management interface 492 to provide out of band monitoring, maintenance, and control of the elements of the information handling system. As such, BMC 490 represents a processing device different from processor 402 and processor 404, which provides various management functions for information handling system 400. For example, BMC 490 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 490 can vary considerably based on the type of information handling system. BMC 490 can operate in accordance with an Intelligent Platform Management Interface (IPMI). Examples of BMC 490 include an Integrated Dell^{®}Remote Access Controller (iDRAC).

Management interface 492 represents one or more out-of-band communication interfaces between BMC 490 and the elements of information handling system 400, and can include an I²C bus, a System Management Bus (SMBUS), a Power Management Bus (PMBUS), a Low Pin Count (LPC) interface, a serial bus such as a USB or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/OS execution environment on information handling system 400, that is apart from the execution of code by processors 402 and 404 and procedures that are implemented on the information handling system in response to the executed code.

BMC 490 operates to monitor and maintain system firmware, such as code stored in BIOS/EFI module 442, option ROMs for graphics adapter 430, disk controller 450, add-on resource 474, network interface 480, or other elements of information handling system 400, as needed or desired. In particular, BMC 490 includes a network interface 494 that can be connected to a remote management system to receive firmware updates, as needed or desired. Here, BMC 490 receives the firmware updates, stores the updates to a data storage device associated with the BMC, and transfers the firmware updates to an NVRAM of the device or system that is the subject of the firmware update, thereby replacing the currently operating firmware associated with the device or system, and reboots information handling system, whereupon the device or system utilizes the updated firmware image.

BMC 490 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 490, an interface defined by the Distributed Management Taskforce (DMTF) (such as a Web Services Management (WSMan) interface, a Management Component Transport Protocol (MCTP) or, a Redfish^{®}interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 490 is included on a main circuit board (such as a baseboard, a motherboard, or any combination thereof) of information handling system 400 or is integrated onto another element of the information handling system such as chipset 410, or another suitable element, as needed or desired. As such, BMC 490 can be part of an integrated circuit or a chipset within information handling system 400. An example of BMC 490 includes an iDRAC, or the like. BMC 490 may operate on a separate power plane from other resources in information handling system 400. Thus BMC 490 can communicate with the management system via network interface 494 while the resources of information handling system 400 are powered off. Here, information can be sent from the management system to BMC 490 and the information can be stored in a RAM or NVRAM associated with the BMC. Information stored in the RAM may be lost after power-down of the power plane for BMC 490, while information stored in the NVRAM may be saved through a power-down/power-up cycle of the power plane for the BMC.

Information handling system 400 can include additional components and additional buses, not shown for clarity. For example, information handling system 400 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 400 can include multiple CPUs and redundant bus controllers. One or more components can be integrated together. Information handling system 400 can include additional buses and bus protocols, for example, I²C and the like. Additional components of information handling system 400 can include one or more storage devices that can store machine-executable code, one or more communications ports for communicating with external devices, and various input and output (I/O) devices, such as a keyboard, a mouse, and a video display.

For purposes of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 400 can include processing resources for executing machine-executable code, such as processor 402, a programmable logic array (PLA), an embedded device such as an SoC, or other control logic hardware. Information handling system 400 can also include one or more computer-readable media for storing machine-executable code, such as software or data.

Although FIG. 2 shows example blocks of method 200 in some implementations, method 200 may include additional blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, an SoC, or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor, information associated with an operating system, a central processing unit, and a graphics processing unit of an information handling system;
determining a set of dither patterns based on the received information associated with the operating system, central processing unit, and graphics processing unit of the information handling system; and
applying the set of dither patterns to an image prior to displaying the image.

2. The method of claim 1, wherein the information includes an operating system identifier, a central processing unit identifier, and a graphics processing unit identifier.

3. The method of claim 1, further comprising: transmitting a signal associated with the set of dither patterns to a timing controller.

4. The method of claim 3, further comprising: switching to the set of dither patterns stored in a memory accessible by the timing controller based on the signal.

5. The method of claim 3, wherein the signal is transmitted to a multiplexer of the timing controller.

6. The method of claim 1, further comprising: maintaining a mapping of combinations of operating system identifiers, central processing unit identifiers, and graphics processing unit identifiers to sets of dither patterns.

7. The method of claim 6, wherein each one in the sets of dither patterns is optimized for a particular combination of an operating system identifier, a central processing unit identifier, and a graphics processing unit identifier.

8. A display device, comprising:
a processor; and
a memory coupled to the processor, the memory having program instructions stored thereon that upon execution cause the processor to:
receive information associated with an operating system, a central processing unit, and a graphics processing unit of an information handling system;
determine a set of dither patterns based on the received information associated with the operating system, central processing unit, and graphics processing unit of the information handling system; and
apply the set of dither patterns to an image prior to displaying the image on the display device.

9. The display device of claim 8, wherein the information includes an operating system identifier, a central processing unit identifier, and a graphics processing unit identifier.

10. The display device of claim 8, wherein the execution of the program instructions further causes the processor to: transmit a signal associated with the set of dither patterns to a timing controller.

11. The display device of claim 10, wherein the execution of the program instructions further causes the processor to: select the set of dither patterns accessible by the timing controller based on the signal.

12. The display device of claim 10, wherein the signal is transmitted to a multiplexer of the timing controller.

13. The display device of claim 8, wherein the execution of the program instructions further causes the processor to: maintain a mapping of combinations of operating system identifiers, central processing unit identifiers, and graphics processing unit identifiers to sets of dither patterns.

14. The display device of claim 13, wherein each one in the sets of dither patterns is optimized for a particular combination of an operating system identifier, a central processing unit identifier, and a graphics processing unit identifier.

15. A non-transitory computer-readable medium to store instructions that are executable to perform operations comprising:
receiving information associated with an operating system, a central processing unit, and a graphics processing unit of an information handling system;
determining a set of dither patterns based on the received information associated with the operating system, central processing unit, and graphics processing unit of the information handling system; and
applying the set of dither patterns to an image prior to displaying the image.

16. The non-transitory computer-readable medium of claim 15, wherein the information includes an operating system identifier, a central processing unit identifier, and a graphics processing unit identifier.

17. The non-transitory computer-readable medium of claim 15, wherein the operations further comprise: transmitting a signal associated with the set of dither patterns to a timing controller.

18. The non-transitory computer-readable medium of claim 17, wherein the operations further comprise: selecting the set of dither patterns stored in a memory accessible by the timing controller based on the signal.

19. The non-transitory computer-readable medium of claim 17, wherein the signal is transmitted to a multiplexer of the timing controller.

20. The non-transitory computer-readable medium of claim 15, wherein the operations further comprise: maintaining a mapping of combinations of operating system identifiers, central processing unit identifiers, and graphics processing unit identifiers to sets of dither patterns.
